(19) United States
(12) Patent Application Publication
(10) Pub. No.: US 2004/0136727 A1
(43) Pub. Date: Jul. 15, 2004

(54) Optical transmission system comprising a supervisory system

(76) Inventors: Daniele Androni, Gragnano (IT); Andrea Fregosi, Milano (IT); Corrado Rocca, Monza (IT); Alessandro Vitale, Milano (IT)

Correspondence Address: FINNEGAN, HENDERSON, FARABOW, GARRETT & DUNNER, LLP, 1300 I STREET, NW, WASHINGTON, DC, 20005, US

(21) Appl. No.: 10/476,272

(22) PCT Filed: Apr. 16, 2002
(86) PCT No.: PCT/EP02/04204

(30) Foreign Application Priority Data
Apr. 30, 2001 (EP) 012015970
May 4, 2001 (US) 60288483

(51) Int. Cl. H04B 10/02

(52) U.S. Cl. 398/173

(57) ABSTRACT

An optical communication line having a first control unit; an optical transmission fibre connected to the first control unit for transmitting an optical signal; and an optical amplification unit inserted along the optical transmission fibre for amplifying the optical signal. The optical amplification unit has an optical amplifier for amplifying the optical signal, a magneto-optical attenuator connected to the optical amplifier, and a control device for regulating the light transmissivity of the magneto-optical attenuator, wherein the first control unit has a magneto-optical attenuator and a control device for regulating the light transmissivity of the magneto-optical attenuator so as to superimpose service informations on the optical signal. In the optical amplification unit, the control device is suitable to regulate the light transmissivity of the magneto-optical attenuator so as to superimpose service informations on the optical signal.

### DESCRIPTION

The present invention relates to an optical transmission system comprising a supervisory system. More in particular, the present invention relates to an optically amplified optical communication line comprising a first control unit, a second control unit, an optical transmission fibre and an optical amplification unit, said line being suitable to transmit supervisory (or service) informations from the control units to the optical amplification unit and vice versa.

Moreover, the present invention relates to a control unit and an optical amplification unit suitable to be used in said optical communication line and an optical transmission (or communication) system comprising said line.

In the present description and claims, the expression

“service informations” is used to indicate command informations suitable to set predetermined system parameters (such as, for example, the gain and the output power of an optical amplifier), query informations suitable to check the operation status of a device and/or communications between the maintenance and/or supervisory personnel operating in a point of the line, at an intermediate or end station of the same line;

“magneto-optical attenuator” is used to indicate a device suitable to reduce the amplitude and/or the power of an optical signal through a magneto-optical effect, that is to say, through the application of a magnetic field to the material forming the device, so as to change its optical features in a predetermined way.

In an optically amplified optical communication line, and especially, in a submarine optically amplified optical communication line, there is the very felt need of exchanging service informations between optical amplifiers of the line and central control and supervisory units also when the line is in service.

Methods for sending supervisory informations from an optical amplifier of a line to a central control unit and/or from a central unit to an optical amplifier are known.

For example, EP 0 675 610 teaches to modulate the pump radiation of an optical amplifier through a modulating signal carrying supervisory informations. Such modulating signal has a high modulation frequency, that is, a modulation period that is less than the fluorescence time of erbium ions, so as not to affect the gain of the optical amplifier. In this way, the supervisory informations are sent using as optical carrier the excess pump radiation that does not contribute to the optical amplifier pumping.

However, this solution can only be used with pump radiations at about 1480 nm, since a pump radiation at about 980 nm would be totally attenuated along optical fibre spans between one amplifier and the other one.

Moreover, since the excess pump radiation carrying supervisory informations from one amplifier and the other one of the optical communication line is attenuated along the optical fibre span separating the optical amplifiers and then it is absorbed by the following optical amplifier, it must be regenerated at each optical amplifier. This implies the presence of proper additional circuits and thus, a higher system complexity.

U.S. Pat. No. 5,625,481 teaches to modulate the spontaneous emission of an erbium-doped optical fibre amplifier with a supervisory signal through a band pass optical filter whose transmission characteristic is changed in function of the supervisory signal.

U.S. Pat. No. 6,111,687 teaches to use a band pass optical filter for modulating an optical signal in output from an optical amplifier with such amplitude and frequency as to not disturb the data transmission performed by the optical signal. Such modulation allows the optical amplifier to transmit supervisory messages.

However, since the optical filter described in this document has also the function of limiting the spontaneous emission generated by the optical amplifier around the signal wavelength (that is to say, it has a relatively narrow band), the solution described in said document is not suitable to be used in a wavelength division multiplexing (or WDM) optical communication system.

EP 0 961 514 discloses the modulation of the pump radiation of a transmission optical amplifier for transmitting an overmodulation frequency (tone) along a protected portion of a guided optical path of an optical communication system. The preferred modulation frequency is comprised between 5 and 20 KHz.

EP 0 751 635 describes a supervisory system for a WDM optical communication system for transmitting a command signal from a terminal station to an erbium-doped optical fibre amplifier and response signals from an erbium-doped optical fibre amplifier to the terminal station. A first method described for transmitting the command signal consists in using the same command signal to directly modulate, one by one, a plurality of optical sources that generate laser beams at different wavelengths. The laser beams at different wavelengths are then externally modulated by the respective main signals to be transmitted along the system and thus, wavelength multiplexed. According to a second method, on the other hand, the laser beams at different wavelengths are first externally modulated by the respective main signals, then they are wavelength multiplexed in a single WDM optical signal; afterwards, the latter is modulated externally in function of the command signal through a lithium niobate modulator (LiNbO₃). On the other hand, as regards the response signals sent by the erbium-doped optical amplifiers to the terminal stations, they are transmitted by directly modulating the pump source of the optical amplifiers in function of the response signal to be transmitted so as to modulate the gain of the erbium-doped optical amplifiers. The command signals have a frequency in the range of 10 MHz whereas response signals have a frequency in the range of KHz.

As regards the second method for transmitting command signals, the Applicant notes that the use of a LiNbO₃ modulator implies an increase in costs, dimensions and consumption, high insertion losses and a decline in reliability of the line, which are unacceptable especially in a submarine optical communication line.

Thus, according to the Applicant, even though the LiNbO₃ modulator has a rise and fall time that is typical of optical modulators, that is, in the range of tenths of picoseconds, it is not suitable to be used as modulator for the transmission of service signals in a submarine optical communication system.

The Applicant notes that the same remarks apply also to other conventional optical modulators, such as for example, electro-absorption semiconductor modulators.

In turn, as regards the first method for transmitting command signals, the Applicant notes that since such method requires a proper control electronics for the direct modulation of each laser source, it implies an increase in complexity of electric connections and wiring, in costs and in dimensions. Moreover, it introduces the need of a calibration of the modulation depth for each laser source, with a consequent increase of the complexity and of the production and installation costs. Such disadvantages are increasingly important as the number of signals to transmit in a WDM optical communication system increases.

As regards the method for modulating the pump source of erbium-doped active optical fibre optical amplifiers for the transmission of response signals, the Applicant notes that to transfer the pump signal modulation to the gain of the optical amplifier, and thus, to the main optical signal that propagates along the optical amplifier, the modulation must be performed with a higher modulation period than the fluorescence time of erbium ions.

The modulation frequency with which the response signal is transmitted must thus be selected considering both the fluorescence time of erbium ions, that is, the fact that an erbium-doped optical amplifier behaves like a low pass filter with respect to a modulation of its pump radiation, and that the response signal must propagate along a chain of optical amplifiers that, on the contrary, behave as high pass filters with respect to a signal modulated at their input.

The Applicant has verified that a good compromise between these two needs is obtained with a modulation frequency around 10-20 KHz for an output power from the active fibre of the optical amplifier of 4 dBm. For example, in case of transmission of eight channels along a cascade of 100 erbium-doped optical amplifiers with an optical power per channel equal to 5 dBm and a total optical power in output from the active optical fibre of each optical amplifier equal to 4 dBm, the attenuation of the electrical signal around 10 KHz, at the end of the optical amplifier cascade, is of about 6 dB (typically acceptable value since it is easily recoverable in reception as regards both the sensitivity and the dynamics of the receiver).

However, the Applicant has noted that, in the case of erbium-doped active optical fibre optical amplifiers, as the number of channels of a WDM optical communication system increases and thus, as the necessary optical power in output from the active optical fibre of the optical amplifiers increases, also the attenuation introduced by such optical amplifiers at low frequencies, that is, around 10-20 KHz, increases.

Considering that in an optical communication line a WDM optical signal must typically propagate along a chain of optical amplifiers (for example, along 100 optical amplifiers in cascade), the attenuation introduced by each optical amplifier on the low frequency components (for example, around 10-20 KHz) of the WDM optical signal can make the service informations be lost at the end of the optical amplifier chain.

For example, in case of transmission of 64 channels along a cascade of 100 erbium-doped optical amplifiers with an optical power per channel of −5 dBm and a total optical power in output from the active optical fibre of each optical amplifier equal to 13 dBm, the attenuation of the electrical signal at the end of the cascade of optical amplifiers is of about 40 dB around the frequency of 10 KHz and of about 4 dB around the frequency of 40 KHz.

Thus, passing from 8 to 64 channels and from 4 dBm to 13 dBm of total optical power in output from the active optical fibre of each optical amplifier, the attenuation introduced on the electrical signal becomes unacceptable around 10 KHz whereas it returns to an acceptable value (since it is easily recoverable in reception as regards both the sensitivity and the dynamics of the receiver) around, for example, 40 KHz.

The Applicant has thus noticed that in the presence of a high number of optical amplifiers and of channels and of a high output power from the active optical fibre of the optical amplifiers, it is necessary to transmit service informations at a high modulation frequency (for example, more than 10-20 KHz).

However, such problem cannot be solved by modulating the pump radiation of the optical amplifier at a higher frequency since, as already said, with respect to a modulation of the pump radiation the optical amplifier behaves as a low pass filter.

The Applicant has therefore faced the technical problem of providing an optically amplified optical communication line capable of transmitting service informations in the presence of a high number (for example, more than 20 with a power per channel of-5 dBm) of optical signals at different wavelengths, which should guarantee a relatively wide and flat optical band, limited costs, consumption and size and high reliability, so that it can be used in a submarine WDM optical communication system.

The Applicant has found that such problem can be solved by superimposing the service informations from and to the optical amplifiers on the WDM optical signal transmitted along the line through the use of a magneto-optical attenuator.

In fact, the Applicant has found that even though a magneto-optical attenuator has quite a high typical rise and fall time (corresponding to frequencies in the range of KHz or less), it is capable of externally modulating an optical signal at a frequency of above 10 KHz around a predetermined operating point since its response in frequency can have a small signals band of about 300 KHz.

In the present description, the expression “small signal” is suitable to indicate a signal suitable to impart a modulation to a main optical signal having an amplitude not greater than 25% of the power of the main optical signal.

Moreover, a magneto-optical attenuator has limited costs and consumptions, small sizes, and it has the necessary reliability features to be used in a submarine optical communication system; it has a sufficiently wide and flat optical band to be used in the range of wavelengths of interest of the third transmission window of a WDM optical communication system.

The Applicant has noted that the magneto-optical attenuator can be advantageously used to superimpose service informations on a WDM optical signal:

at the transmitter side, after multiplexing all channels in a single WDM optical signal, for transmitting service informations to the optical amplifiers and/or to the receiver side;

at the optical line amplifiers for transmitting service informations to the transmitting and/or receiving stations; and

both at the transmitter side and at the optical line amplifiers.

N. Fukushima et al. (“Non-mechanical variable attenuator module using Faraday effect”, Optical Amplifiers and Their Applications Topical meeting, '96, 154/FD9-1—157/FD9-4) describe the structure of a magneto-optical attenuator. In their article, the Authors state that the attenuator has a response time of about 300 μs (corresponding to about 3.3 KHz) with a driving current of 40 mA.

Moreover, EP 0 805 571 describes the use of a magneto-optical attenuator associated to an optical amplifier. However, this document does not teach the use of said attenuator for superimposing service informations on a WDM optical signal. In fact, it describes an optical amplification equipment comprising an optical amplifier, an optical attenuator (for example, a magneto-optical attenuator) and a controller. The light transmissivity of the optical attenuator is regulated by the controller so as to maintain the power level of the amplified WDM optical signal at a constant level that depends on the number of channels of the WDM signal.

In this document, the magneto-optical attenuator is thus used for maintaining the power per channel at a constant level as the number of channels comprised in the WDM optical signal changes. When the number of channels changes, the light transmissivity of the attenuator is varied so as to maintain the power of the amplified WDM optical signal at another level of constant power, corresponding to the new number of channels.

In a first aspect thereof, the present invention relates to an optical communication line comprising

a first control unit;

an optical transmission fibre for transmitting an optical signal, connected to the first control unit; and

an optical amplification unit inserted along said optical transmission fibre for amplifying the optical signal, said optical amplification unit comprising, in turn,

an optical amplifier for amplifying the optical signal,

a magneto-optical attenuator connected to said optical amplifier, and

a control device for regulating the light transmissivity of the magneto-optical attenuator,

characterised in that

the first control unit comprises a magneto-optical attenuator and a control device for regulating the light transmissivity of the magneto-optical attenuator so as to superimpose service informations on the optical signal; and in that

in the optical amplification unit, the control device is suitable to regulate the light transmissivity of the magneto-optical attenuator so as to superimpose service informations on the optical signal.

The optical communication line according to the first aspect of the invention allows sending service informations by using a magneto-optical attenuator both in the control unit and in the optical amplification unit.

The use of the magneto-optical attenuator allows transmitting service informations at a modulation frequency that is higher than 10-20 KHz thus allowing to overcome the above disadvantage that, as the number of channels of a WDM optical communication system increases and thus, as the optical power in output from the active optical fibre of the optical amplifiers increases, the attenuation introduced by optical amplifiers at low frequencies increases too.

Thus, the optical communication line of the invention allows transmitting service informations in the presence of a high number of channels and it is upgradable to transmit a higher number of channels than that for which it is first designed.

Moreover, the use of the magneto-optical attenuator allows reducing costs, consumptions and sizes, increasing the line reliability and having a sufficiently wide and flat optical band in the range of wavelengths of interest of the third transmission window of a WDM optical communication system.

Moreover, the use of the magneto-optical attenuator is advantageous since, in case of rupture of its driving circuit it sets itself to a minimum attenuation level, thus avoiding to affect data transmission along the optical communication line.

Moreover, since the optical communication line of the invention is suitable to send service informations from the control unit to the optical amplification unit through the superimposition of said informations on a WDM optical signal, in case of WDM transmission it allows avoiding the use of as many command circuitries as the channels to be transmitted for directly modulating the laser sources of the terminal stations and thus, it allows reducing the number of electrical connections, costs and sizes, simplifying the wiring and considerably facilitating the upgrade of the system to transmit a higher number of channels than that for which it is first designed.

In addition, in the optical communication line of the invention the handling of the service informations transmission is universal and independent of the terminal stations of an optical communication system.

This is an advantageous aspect of the present invention since in practice, the producers of terminal stations, especially in long connections, can be different from the producers of the optical communication lines. Thus, the line of the invention simplifies the complex operation of adaptation intended to make the terminal stations compatible (communicating) with the optical communication line.

Typically, the optical signal is a WDM optical signal.

Advantageously, the WDM optical signal comprises more than 8 channels.

Preferably, the optical communication line is submarine. That is to say, it comprises at least one portion (for example, comprising the optical amplification unit) suitable to be installed below the sea level. The components belonging to such portion meet the requirements of a submarine application, for example in terms of reliability, consumption and size.

In the amplification unit and in the first control unit, the control device is advantageously suitable to modulate the light transmissivity of the magneto-optical attenuator around a predetermined operating point so as to modulate the amplitude of the optical signal in function of the service informations to transmit.

Advantageously, the service informations have a transmission band comprised between 10 and 300 KHz. Preferably, such band is comprised between 20 and 200 KHz. More preferably, it is comprised between 30 and 150 KHz. Even more preferably, it is comprised between 40 and 100 KHz. As already said above, a modulation frequency that is more than 10 KHz allows increasing the optical power in output from the active optical fibre of an optical amplifier thus making the optical communication line upgradable to transmit a high number of channels.

In a preferred embodiment, the amplitude of the optical signal in the optical amplification unit is modulated at a different modulation frequency than that with which the amplitude of the optical signal in the first control unit is modulated. This allows an easier distinction of the service informations transmitted by the optical amplification unit from those transmitted by the first control unit.

The modulation amplitude with which the amplitude of the optical signal is modulated in function of the service informations to be transmitted is preferably less than 25% of the total optical power of the optical signal in input to the magneto-optical attenuator. More preferably, it is less than 20%. Even more preferably, it is less than 10%. Such values allow a considerable non-degradation of the transmission of the optical signal.

Advantageously, the modulation amplitude is more than 2% of the total optical power of the optical signal in input to the magneto-optical attenuator. Preferably, it is more than 4%. For example, it is 5% of the total optical power. Such values allow maintaining the service channel at an appreciable power level.

Advantageously, the magneto-optical attenuator has a transmission band for small signals that is less than 1 MHz. Preferably, such band is less than 700 KHz. More preferably, it is less than 500 KHz. In fact, the Applicant deems that a transmission band having a higher upper limit than the above values requires the use of more sophisticated manufacturing technologies than those used for producing a magneto-optical attenuator, thus implying an increase of costs and a reduction of reliability of the device used for superimposing service informations on the optical signal.

Advantageously, in the optical amplification unit, the magneto-optical attenuator is connected to the output of the optical amplifier.

In this case, the predetermined operating point around which the control device modulates the light transmissivity of the magneto-optical attenuator is typically selected so as to impart an attenuation to the optical signal in output from the optical amplifier selected in function of the number of channels carried by the optical signal. This allows regulating the total optical power in output from the optical amplification unit in function of the number of channels carried by the optical signal (for example, so that the channels in output from it have a constant optical power independently of the number of transmitted channels).

According to an alternative, when the optical amplifier of the optical amplification unit is of the two-stage type, the magneto-optical attenuator can be inserted between said two stages.

Typically, the control device of the optical amplification unit is also suitable to extract the service informations from the optical signal. Advantageously, said control device is also suitable to process the service informations extracted from the optical signal and modulate the light transmissivity of the magneto-optical attenuator in function of the result of such processing.

Advantageously, the optical amplification unit comprises an optical element suitable to pick up a portion of optical power from the optical signal and send it to the control device of the optical amplification unit. In this case, the control device extracts the service informations from the portion of power of the optical signal thus picked up.

Typically, the optical amplifier is an active optical fibre optical amplifier doped with rare earth. A typical example of rare earth used is erbium.

Advantageously, the optical communication line also comprises a second control unit. In this case, the optical transmission fibre is typically inserted between the first control unit and the second control unit for transmitting the optical signal from the first control unit to the second control unit.

Typically, the second control unit comprises a control device suitable to extract service informations from the optical signal.

Advantageously, the second control unit comprises an optical element suitable to pick up a portion of optical power from the optical signal and to send it to the control device. In this case, the control device extracts the service informations from the portion of power of the optical signal thus picked up.

When the length of the link requires it, the optical communication line comprises a plurality of optical amplification units inserted along the optical transmission fibre at a predetermined distance from one another.

As regards the structural and functional features of said optical amplification units, reference shall be made to what described with reference to the above mentioned optical amplification unit.

In an embodiment, the optical communication line is bidirectional.

In this case, it advantageously also comprises a second optical transmission fibre for transmitting a backward optical signal from the second control unit to the first control unit, the first optical transmission fibre transmitting a forward optical signal from the first control unit to the second control unit.

Moreover, the optical amplification unit advantageously also comprises a backward optical amplifier for amplifying the backward optical signal and a backward magneto-optical attenuator.

Moreover, the control device of the optical amplification unit is advantageously also suitable to modulate the light transmissivity of the backward magneto-optical attenuator so as to superimpose service informations on the backward optical signal.

Moreover, in this bidirectional embodiment, the control device of the optical amplification unit is also typically suitable to extract service informations from the backward optical signal.

Moreover, the optical amplification unit advantageously comprises also an optical element suitable to pick up a portion of optical power from the backward optical signal and to send it to the control device of the optical amplification unit. In this case, the control device extracts the service informations from the portion of power of the backward optical signal thus picked up.

Moreover, said control device is also suitable to process the service informations extracted from the backward optical signal and to modulate the light transmissivity of the backward magneto-optical attenuator in function of the result of such processing.

According to a variant, the control device of the optical amplification unit is suitable to

process the service informations picked up from the forward optical signal and modulate the light transmissivity of the backward magneto-optical attenuator in function of the result of such processing; and

process the service informations picked up from the backward optical signal and to modulate the light transmissivity of the forward magneto-optical attenuator in function of the result of such processing.

This variant is advantageous since it allows the first and the second control unit to receive directly from the optical amplification unit the response to the service informations sent by them to the same optical amplification unit.

In the bidirectional embodiment, the second control unit preferably comprises also a backward magneto-optical attenuator connected to the second transmission fibre.

In this case, the control device of the second control unit is also advantageously suitable to modulate the light transmissivity of the backward magneto-optical attenuator so as to superimpose service informations on the backward optical signal.

Advantageously, the control device of the second control unit is also suitable to process the service informations picked up from the forward optical signal and to modulate the light transmissivity of the backward magneto-optical attenuator in function of the result of such processing.

Moreover, in the bidirectional embodiment, the control device of the first control unit is also suitable to pick up the service informations from the backward optical signal. Moreover, it is also typically suitable to process the service informations picked up from the backward optical signal and modulate the light transmissivity of the forward magneto-optical attenuator in function of the result of such processing.

Advantageously, the first control unit also comprises an optical element suitable to pick up a portion of optical power from the backward optical signal and send it to the control device. In this case, the control device extracts the service informations from the portion of power of the backward optical signal thus picked up.

In a second aspect thereof, the present invention relates to an optical amplification unit comprising

an optical amplifier for amplifying an optical signal,

a magneto-optical attenuator connected to said optical amplifier, and

a control device for regulating the light transmissivity of the magneto-optical attenuator,

characterised in that the control device is suitable to regulate the light transmissivity of the magneto-optical attenuator so as to superimpose service informations on the optical signal.

As regards the structural and functional features of the optical amplification unit, of the magneto-optical attenuator and of the control device, reference shall be made to what described above with reference to the first aspect of the invention.

Typically, the optical signal is a WDM optical signal.

In a third aspect thereof, the present invention relates to an optical communication line comprising

an optical transmission fibre for transmitting an optical signal;

a first control unit for sending service informations along the optical transmission fibre; and

an optical amplification unit inserted along said optical transmission fibre for amplifying the optical signal, said optical amplification unit comprising, in turn,

an optical amplifier for amplifying the optical signal,

a magneto-optical attenuator connected to said optical amplifier,

a control device for regulating the light transmissivity of the magneto-optical attenuator,

characterised in that in the optical amplification unit, the control device is suitable to regulate the light transmissivity of the magneto-optical attenuator so as to superimpose service informations on the optical signal.

As regards the structural and functional features of the optical communication line, of the optical amplification unit, of the optical amplifier, of the magneto-optical attenuator and of the control device, reference shall be made to what described above with reference to the first aspect of the present invention.

Advantageously, the first control unit is of the type described above with reference to the first aspect of the present invention.

Typically, the optical signal is a WDM signal.

In a fourth aspect thereof, the present invention relates to an optical communication line comprising

an optical transmission fibre for transmitting an optical signal;

a first control unit for sending service informations along the optical transmission fibre; and

an optical amplification unit inserted along said optical transmission fibre for amplifying the optical signal,

characterised in that the first control unit comprises a magneto-optical attenuator and a control device for regulating the light transmissivity of the magneto-optical attenuator so as to superimpose the service informations on the optical signal.

As regards the structural and functional features of the optical communication line, of the first control unit and of the optical transmission fibre, reference shall be made to what described above with reference to the first aspect of the present invention.

Advantageously, the optical amplification unit is of the type described above with reference to the first aspect of the present invention.

Typically, the optical signal is a WDM optical signal.

In a fifth aspect thereof, the present invention relates to a control unit comprising

a magneto-optical attenuator, and

a control device for regulating the light transmissivity of the magneto-optical attenuator,

characterised in that the control device is suitable to regulate the light transmissivity of the magneto-optical attenuator so as to superimpose service informations on an optical signal.

As regards the structural and functional features of the control unit, of the magneto-optical attenuator and of the control device reference shall be made to what described above with reference to the first aspect of the present invention.

Typically, the optical signal is a WDM optical signal.

In a sixth aspect thereof, the present invention relates to an optical communication system comprising

a first terminal station for providing an optical signal;

a first control unit for transmitting service informations, connected to said first terminal station;

a second terminal station for receiving said optical signal;

a second control unit for receiving service informations, connected to said second terminal station;

an optical transmission fibre for transmitting the optical signal from the first control unit to the second control unit; and

an optical amplification unit inserted along said optical transmission fibre for amplifying the optical signal,

characterised in that the first control unit comprises a magneto-optical attenuator and a control device for regulating the light transmissivity of the magneto-optical attenuator so as to superimpose service informations on the optical signal provided by the first terminal station.

As regards the structural and functional features of the control units, of the optical transmission fibre and of the optical amplification unit, reference shall be made to what described above with reference to the first aspect of the present invention.

Typically, the optical signal is a WDM optical signal.

In this case, the first terminal station typically comprises a plurality of light sources suitable to provide a plurality of optical signals at different wavelengths and a multiplexing device for multiplexing in wavelength the plurality of optical signals in a single WDM signal.

Moreover, the second terminal station typically comprises a demultiplexing device for demultiplexing in wavelength the WDM optical signal in a plurality of optical signals at different wavelengths and a plurality of photodetectors for receiving said optical signals.

In a bidirectional embodiment, the second terminal station is suitable to provide a backward optical signal.

It typically comprises a plurality of light sources suitable to provide a plurality of backward optical signals at different wavelengths and a multiplexing device for multiplexing in wavelength the plurality of optical signals in a single backward WDM optical signal.

Moreover, in the bidirectional embodiment, the first terminal station is suitable to receive the backward optical signal.

It typically comprises a demultiplexing: device for wavelength demultiplexing the backward WDM optical signal in a plurality of backward optical signals at different wavelengths and a plurality of photodetectors for receiving said optical signals.

In a seventh aspect thereof, the present invention relates to an optical communication system comprising

a first terminal station for providing an optical signal;

a first control unit for sending service informations, connected to said first terminal station;

a second terminal station for receiving said optical signal;

a second control unit for receiving service informations, connected to said second terminal station;

an optical transmission fibre for transmitting the optical signal from the first control unit to the second control unit; and

an optical amplification unit inserted along said optical transmission fibre for amplifying the optical signal, said optical amplification unit comprising, in turn,

an optical amplifier for amplifying the optical signal,

a magneto-optical attenuator connected to said optical amplifier,

a control device for regulating the light transmissivity of the magneto-optical attenuator,

characterised in that in the optical amplification unit the control device is suitable to regulate the light transmissivity of the magneto-optical attenuator so as to superimpose service informations on the optical signal.

As regards the structural and functional features of the optical communication system, of the terminal stations, of the control units, of the optical transmission fibre, of the optical amplification unit, of the optical amplifier, of the magneto-optical attenuator and of the control device, reference shall be made to what described above with reference to the first and the sixth aspect of the present invention.

Typically, the optical signal is a WDM optical signal.

Further features and advantages of the present invention will appear more clearly from the following detailed description of a preferred embodiment thereof, made with reference to the attached drawings. In such drawings,

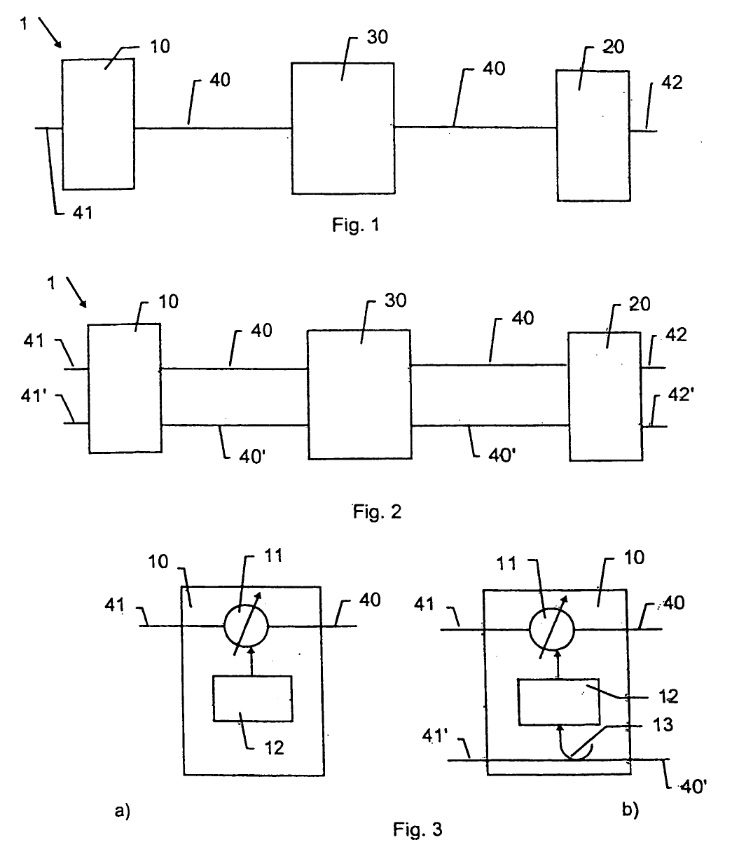

FIG. 1 shows a schematic view of an optical communication line according to the invention;

FIG. 2 shows a schematic view of a bidirectional optical communication line according to the invention;

FIG. 3 shows a schematic view of a first control unit suitable to be used in the optical communication of FIG. 1 (FIG. 3a) and of FIG. 2 (FIG. 3b);

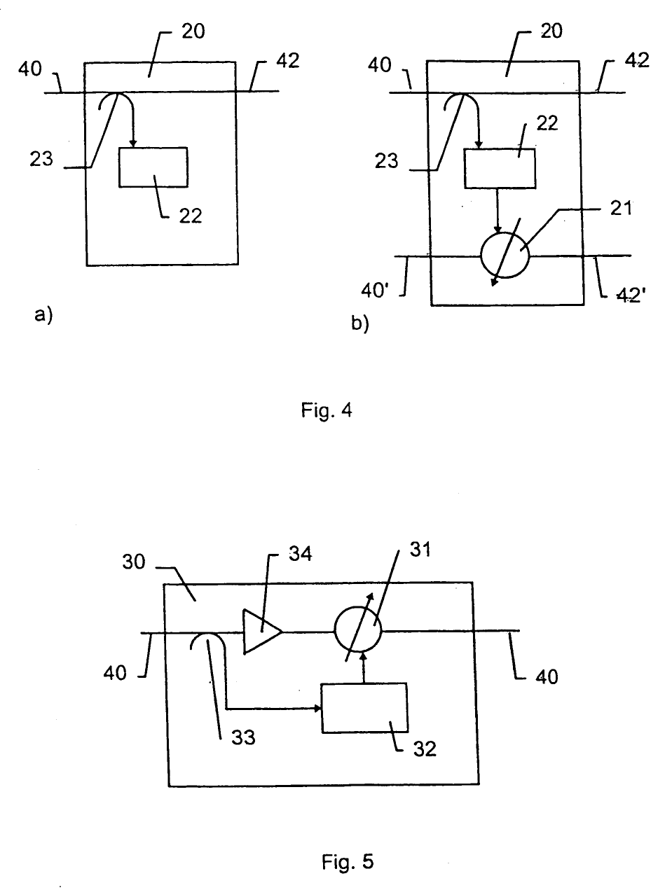

FIG. 4 shows a schematic view of a second control unit suitable to be used in the optical communication line of FIG. 1 (FIG. 4a) and of FIG. 2 (FIG. 4b);

FIG. 5 shows a schematic view of an optical amplification unit suitable to be used in the optical communication line of FIG. 1;

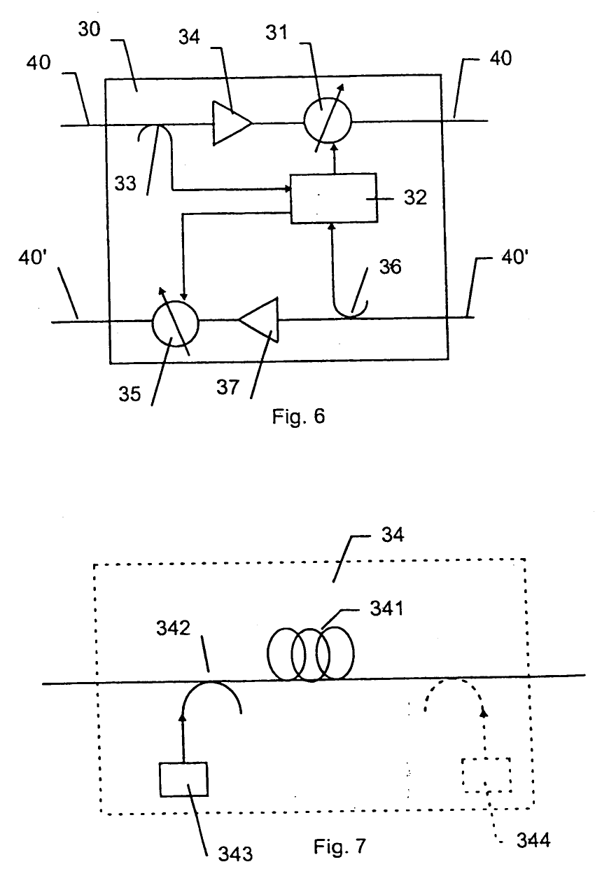

FIG. 6 shows a schematic view of an optical amplification unit suitable to be used in the optical communication line of FIG. 2;

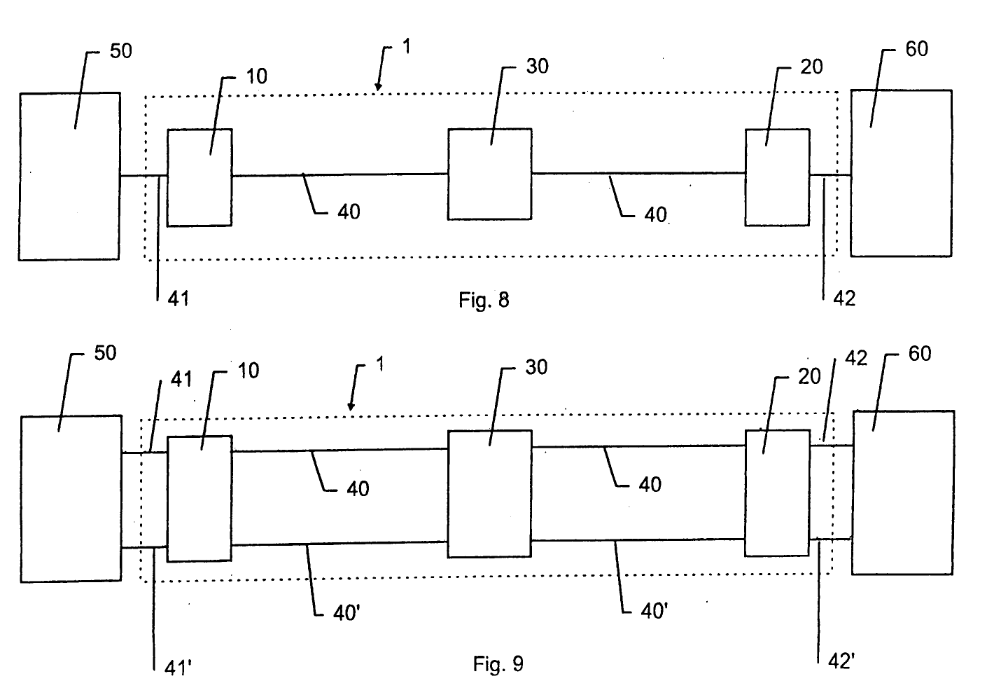

FIG. 7 shows a schematic view of an optical amplifier suitable to be used in the optical amplification units of FIGS. 5 and 6;

FIG. 8 shows a schematic view of an optical communication system comprising the optical communication line of FIG. 1;

FIG. 9 shows a schematic view of an optical communication system comprising the optical communication line of FIG. 2;

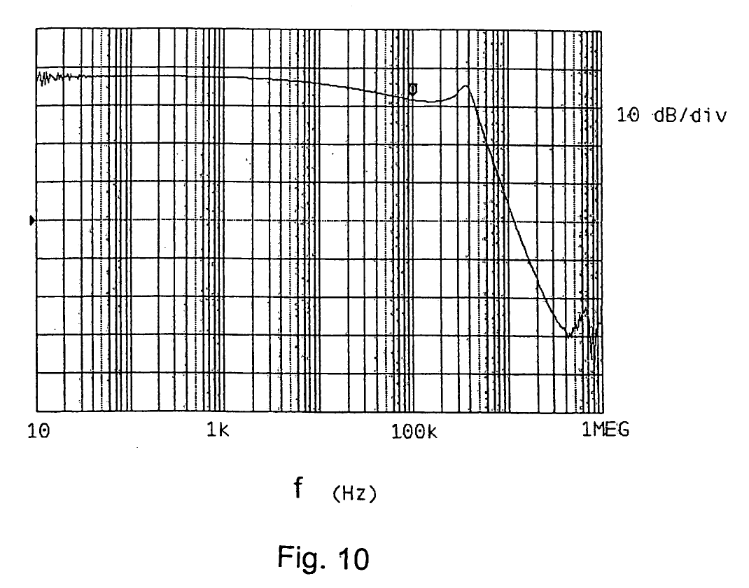

FIG. 10 shows the transfer function of a magneto-optical attenuator experimentally measured by the Applicant.

FIG. 1 shows an optical communication line 1 according to the invention, comprising a first control unit 10, a second control unit 20, an optical transmission fibre 40 for transmitting an optical signal, typically WDM, from the first control unit 10 to the second control unit 20 and an optical amplification unit 30 for amplifying the optical signal.

The optical transmission fibre 40 is an optical fibre of the type conventionally used in an optical communication line or system for transmitting optical signals from one point to another located at a considerable distance.

Typically, said optical transmission fibre 40 comprises a combination of optical fibres suitable to compensate the chromatic dispersion and/or the slope of the chromatic dispersion. For example, the optical transmission fibre 40 comprises a conventional fibre of the NZD (Non Zero Dispersion) type and a conventional single mode (or SMF) fibre produced, for example, by Fibre Ottiche Sud S.p.A. or by CORNING Inc.

The first control unit 10 is suitable to provide service informations to the amplification unit 30 and optionally, to the second control unit 20.

According to a preferred embodiment, the first control unit 10 comprises an input 41 for the WDM optical signal, a magneto-optical attenuator 11 and a control device 12 (FIG. 3a).

Moreover, the first control unit is connected in output to the optical transmission fibre 40.

The magneto-optical attenuator 11, as described for example in the article mentioned above, by Fukushima et al., typically comprises (as the magneto-optical attenuators 21, 31 and 35 described hereinafter) an input optical fibre, an input optical lens, a first birefringent element (wedge), a variable Faraday rotator (comprising a magneto-optical crystal), a second birefringent element (wedge), an output optical lens and an output optical fibre (not shown).

The WDM optical signal coming from the input optical fibre is collimated by the first optical lens and refracted by the first birefringent element where an ordinary light beam and an extraordinary light beam are deflected by two different angles. After a rotation of the polarisation plan of the two light beams in the variable Faraday rotator, part of the two light beams is deflected again along the direction of propagation of the WDM optical input signal through refraction in the second birefringent element and coupled in the optical fibre in output from the output optical lens. The portion of light coupled in the optical output fibre depends on the rotation that is imparted to the polarisation plan of the two ordinary and extraordinary light beams by the variable Faraday rotator.

The Applicant has noted that, through a suitable modulation of the driving current of the variable Faraday rotator, the amplitude of the WDM optical output signal can be modulated.

The described magneto-optical attenuator 11 has a structure that is very similar to that of a conventional optical insulator, except in that in the attenuator, the Faraday rotator is variable thanks to a magneto-optical effect, as described in the above article by Fukushima et al.

Thus, since the technology used for producing optical insulators is suitable to be used in submarine applications, since it meets reliability requirements thereof, the use of the magneto-optical attenuator 11 for sending service informations makes the optical communication line 1 sufficiently reliable to be used also in a submarine optical communication system.

The magneto-optical attenuator 11 is, for example, of the type produced by FDK Corporation, in the model YS-500.

Such attenuator has a typical response time of 320 μs, maximum size of 57 mm, low driving current (0-70 mA) and an optical band comprised between 1530 and 1560 nm. Moreover, it is highly reliable (it has a reliability value in the range of FIT in the typical conditions of a submarine system).

The control device 12 is suitable to modulate the light transmissivity of the magneto-optical attenuator 11 around a predetermined operating point with a small signal so as to modulate the amplitude of the WDM optical signal in function of predetermined service informations to be transmitted, at one or more modulation frequencies.

In fact, the Applicant has noted that even though the magneto-optical attenuator 11 has a rise and fall time of about 320 μs (corresponding to about 3 KHz), it can be used to externally modulate an optical signal at a modulation frequency of more than 10 KHz through a variation of its light transmissivity around an operating point, at the modulation frequency.

For example, the modulation frequency used for transmitting service informations from the first control unit 10 is of 100 KHz.

FIG. 10 shows the transfer function, in function of the frequency f expressed in Hz, of a magneto-optical attenuator manufactured by FDK Corporation, model YS-500, experimentally obtained by the Applicant.

The measure has been performed by making an optical signal pass through the magneto-optical attenuator, detecting the optical signal in output from the attenuator with a photodiode so as to convert it into a corresponding electrical signal, and analysing said electrical signal with a Network Analyzer Anritsu, model MS4630B.

The transfer function has been obtained as follows:

by providing a driving direct current (DC) to the magneto-optical attenuator so as to obtain an attenuation of the optical power of the optical signal equal to 3 dB, besides the insertion losses of the magneto-optical attenuator (setting of the operating point);

by modulating the driving direct current at a frequency of 10 KHz with such modulation amplitude as to modulate the steady attenuation value (3 dB) with a modulation amplitude of 10% (about +/−0.4 dB);

by varying the frequency of the modulation of the AC driving current between 10 Hz e 1 MHz maintaining the operating point and the modulation amplitude of the driving current constant;

by measuring the peak to peak amplitude of the modulation of the optical power in output from the attenuator as the modulation frequency of the driving current varies.

As it can be noted considering the transfer function of FIG. 10, the above magneto-optical attenuator has a band for small signals of about 300 KHz. That is to say, the peak to peak amplitude of the modulation of the optical power in output from the magneto-optical attenuator remains almost unchanged (of about 5 dB or less) as the modulation frequency of the driving current varies between 10 and 300 KHz.

The applicant notes that, even though the magneto-optical attenuator has a rise and fall time of about 320 μs (corresponding to about 3 KHz), it is possible to obtain such wide band for small signals thanks to the fact that the magneto-optical material forming the Faraday rotator promptly responds to small variations of the driving current.

Thus, even though a magneto-optical attenuator is not suitable for transmitting informations at a high frequency and/or with big amplitude variations [for example, it is not capable of obtaining a modulation of the on-off type at high frequency (for example, 2.5 Gbit/s) and with big amplitude variation], it is suitable to be used for transmitting informations, at a relatively low frequency and with small amplitude variations, modulated on an optical carrier. More in particular, it is suitable to superimpose service informations on a WDM optical signal and to obtain both a good transmission of the service informations and a good transmission of the WDM signal.

The operating point of the optical attenuator 11 can be selected in function of the total optical power required at the output of the control unit 10.

The service informations transmitted by the control unit 10 contain, for example, command and query signals for the amplification unit 30. For example, such signals are suitable to set predetermined parameters (for example, the output power and/or the gain of the optical amplifier) of the amplification unit 30 and to check its operating status.

The optical amplification unit 30 is inserted along the optical transmission fibre 40 and it comprises an optical amplifier 34 for amplifying the WDM optical signal, a magneto-optical attenuator 31, a control device 32 and an optical element 33 suitable to pick up a portion of power from the WDM optical signal at the input of the amplification unit 30 (FIG. 5).

As shown in FIG. 7, the optical amplifier 34 comprises an erbium-doped active optical fibre 341 and a pump source 343 (for example, a laser source) for pumping the active optical fibre 341 at a pumping wavelength λp. The pump source 343 is coupled to an input end of the active optical fibre 341 through a wavelength selective coupler 342 (for example, of the fused fibre type) so that the signal and pumping light propagate together through the active optical fibre 341.

However, according to the system requirements, the pump source 343 can be coupled to the output end of the active fibre 341 (as indicated with a broken line with reference numeral 344) so that the signal and pumping line propagate in opposite directions through fibre 341.

Alternatively, a respective pump source can be coupled to each end of fibre 341.

In the case of erbium-doped active optical fibre 341, the wavelength λₚ of the pumping signal is typically equal to about 980 or 1480 nm.

Moreover, the described optical amplifier 34 can optionally comprise more than one optical amplification stage.

The magneto-optical attenuator 31 is, for example, of the type produced by FDK Corporation, model YS-500.

The optical element 33 is, for example, a conventional fused fibre optical coupler having a splitting ratio of 13 dB.

It is suitable to pick up a portion of optical power from the WDM optical signal in input to the optical amplification unit 30 and send it to the control device 32.

For example, the control device 32 comprises an opto-electronic receiver (e.g. a photodiode), an electrical filter capable of extracting from the portion of optical power coming from the optical element 33 the modulation frequency with which the first control unit 10 sends the service informations (for example 100 KHz), an electrical amplifier, a conventional peak detector and a conventional comparator circuit (not shown).

In output from the peak detector, the comparator circuit compares the received and filtered signal with a predetermined threshold for determining the presence or the absence of the modulation frequency and, thus, of the service informations by the first control unit 10.

The control device 32 also comprises a processing unit (not shown) suitable to process the electrical signal in output from the comparator circuit.

For example, said processing unit is a conventional processing unit of the ASIC (Application Specific Integrated Circuit) or of the FPGA (Field Programmable Gate Array) type.

In the presence of service informations by the first-control unit, the processing unit processes said informations to check whether there are command and/or query signals intended for the optical amplification unit 30.

If that is the case, the processing unit executes the commands contained in such signals and, optionally, it generates response signals (for example, on the operating status of the various components of the optical amplification unit 30). Such response signals are the service informations sent by the optical amplification unit 30 to the second control unit 20.

At this point, the processing unit of the control device 32 modulates the light transmissivity of the magneto-optical attenuator 31 around a predetermined operating point so as to modulate the amplitude of the WDM optical signal in input to the magneto-optical modulator 31, in function of the service informations to transmit, at one or more modulation frequencies.

For example, the service informations from the optical amplification unit 30 are transmitted with a modulation frequency equal to about 40 KHz.

The operating point of the optical attenuator 31 can be selected in function of the total optical power required at the output of the optical amplification unit 30.

The second control unit 20 comprises an optical element 23, a control device 22, an output 42 for the WDM optical signal, and it is connected to the optical transmission fibre 40 (FIG. 4a).

The optical element 23 is, for example, a conventional fused fibre optical coupler having a splitting ratio of 13 dB.

It is suitable to pick up a portion of optical power from the WDM optical signal in input to the second control unit 20 and send it to the control device 22.

The control device 22 comprises, for example, an opto-electronic receiver (e.g. a photodiode), an electrical amplifier, a low pass electrical filter and an analog/digital converter (not shown).

The control device 32 also comprises a processing unit (not shown) suitable to process the electrical signal in output from the analog/digital converter.

For example, such processing unit is a conventional processing unit of the DSP (Digital Signal Processor) type suitable to perform a peak detection of the electrical signal, an operation of comparison with a predetermined threshold for determining the presence or absence of the modulation frequency and thus, of the service informations by the optical amplification unit 30 and the processing of the electrical signal, according to system requirements.

In the presence of service informations by the optical amplification unit 30, the processing unit can send such informations to the first control unit 10 according to known methods—for example, using an external Digital Communication Network (DCN).

FIG. 2 shows a bidirectional optical communication line 1 according to the invention.

Such optical communication line 1 is totally similar to that of FIG. 1 except in that it comprises a second transmission fibre 40′ and in that the first control unit 10, the second control unit 20 and the optical amplification unit 30 are of the type shown in FIGS. 3b, 4b and, respectively, 6.

In the bidirectional optical communication line 1 the first optical transmission fibre 40 is suitable to transmit a forward WDM optical signal from the first control unit 10 to the second control unit 20 whereas the second optical transmission fibre 40′ is suitable to transmit a backward WDM optical signal from the second control unit 20 to the first control unit 10.

Of course, the forward and backward terms are only used by way of an example and in a non-limiting manner.

As shown in FIG. 4b, the second control unit 20, besides the optical element 23 and the control device 22, comprises a magneto-optical attenuator 21. Moreover, such unit is also connected to the optical transmission fibre 40′ and it has an input 42′ for the backward WDM optical signal.

Besides extracting service informations from the forward WDM optical signal, the second control unit 20 is also suitable to provide service informations to the amplification unit 30 and, optionally, to the first control unit 10 by means of the magneto-optical attenuator 21.

The magneto-optical attenuator 21 is, for example, of the type produced by FDK Corporation, model YS-500.

Besides performing the above functions, the control device 22 is also suitable to modulate the light transmissivity of the magneto-optical attenuator 21 around a predetermined operating point so as to modulate the amplitude of the backward WDM optical signal, in function of predetermined service informations to transmit, at one or more modulation frequencies.

For example, the service informations from the second control unit 20 are transmitted with a modulation frequency equal to about 100 KHz.

The operating point of the optical attenuator 21 can be selected in function of the total optical power required at the output of the second control unit 20.

The service informations transmitted by the control unit contain, for example, command and/or query signals for the amplification unit 30. For example, such signals are suitable to set predetermined parameters of the amplification unit 30 (value of the output power and of the gain of the backward optical amplifier contained therein) and to check its operating status.

As shown in FIG. 6, the optical amplification unit 30 is totally similar to that of FIG. 5 except in that it also comprises an optical element 36 suitable to pick up a portion of power from the backward WDM optical signal at the input of the amplification unit 30, an optical amplifier 37 for amplifying the backward WDM optical signal, and a backward magneto-optical attenuator 35. Moreover, it is inserted both along the first optical transmission fibre 40 and along the second optical transmission fibre 40′.

The optical amplifier 37 is, for example, of the type shown in FIG. 7.

The magneto-optical attenuator 35 is, for example, of the type produced by FDK Corporation, model YS-500.

The optical element 36 is, for example, a conventional fused fibre coupler having a splitting ratio of 13 dB.

It is suitable to pick up a portion of optical power from the backward WDM optical signal in input to the optical amplification unit 30 and send it to the control device 32.

Besides the components described above with reference to FIG. 5, the control device 32 also comprises a further opto-electronic receiver (e.g. a photodiode), a further electrical filter capable of extracting from the portion of optical power coming from the optical element 36 the modulation frequency with which the second control unit 20 sends the service informations (for example 100 KHz), a further electrical amplifier, a further conventional-peak detector and a further conventional comparator circuit (not shown).

In output from the further peak detector, the further comparator circuit compares the received and filtered signal with a predetermined threshold for determining the presence or the absence of the modulation frequency and, thus, of the service informations by the second control unit 20.

In the presence of service informations by the second control unit 20, the processing unit of the control device 32 described above is also suitable to process such service informations to check whether there are command and/or query signals intended for the optical amplification unit 30.

If that is the case, the processing unit executes the commands contained in such signals and, optionally, it generates response signals (for example, on the operating status of the various components of the optical amplification unit 30). Such response signals are the service informations sent by the optical amplification unit 30 to the first control unit 10.

At this point, the processing unit of the control device 32 modulates the light transmissivity of the magneto-optical attenuator 35 around a predetermined operating point so as to modulate the amplitude of the backward WDM optical signal in input to the magneto-optical modulator 35, in function of the service informations to transmit, at one or more modulation frequencies.

For example, the service informations from the optical amplification unit 30 are transmitted with a modulation frequency equal to about 40 KHz.

The operating point of the optical attenuator 35 can be selected in function of the total optical power required at the output of the optical amplification unit 30.

According to an alternative embodiment, the service informations generated by the control device 32 on account of the service informations received from the second control unit 20 are superimposed on the forward WDM optical signal through the magneto-optical attenuator 31, besides being superimposed on the backward WDM optical signal through the magneto-optical attenuator 35.

According to a further alternative embodiment, the service informations generated by the control device 32 on account of the service informations received from the second control unit 20 are superimposed on the forward WDM optical signal through the magneto-optical attenuator 31 and not to the backward WDM optical signal through the magneto-optical attenuator 35.

Similarly, according to an alternative embodiment, the service informations generated by the control device 32 on account of the service informations received from the first control unit 10 are superimposed also on the backward WDM optical signal through the magneto-optical attenuator 35, besides being superimposed on the forward WDM optical signal through the magneto-optical attenuator 31.

Moreover, according to a further alternative embodiment, the service informations generated by the control device 32 on account of the service informations received from the second control unit 10 are superimposed on the backward WDM optical signal through the magneto-optical attenuator 35 and not—as described with reference to FIG. 5 to the forward WDM optical signal through the magneto-optical attenuator 31.

In the bidirectional optical communication line 1, besides the magneto-optical attenuator 11 and the control device 12, the first control unit 10 also comprises an optical element 13 suitable to pick up a portion of optical power from the backward WDM optical signal in input to the first control unit 10 and send it to the control device 12 (FIG. 3b).

Moreover, besides comprising the input 41 and being connected to the first optical transmission line 40, the first control unit 10 of FIG. 3b further comprises an output 41′ for the backward WDM optical signal and it is connected to the second optical transmission fibre 40′.

The optical element 13 is, for example, a conventional fused fibre optical coupler having a splitting ratio of 13 dB.

The control device 12 comprises, for example, an opto-electronic receiver (e.g. a photodiode), an electrical amplifier, a low pass electrical filter and an analog/digital converter.

The control device 32 also comprises a processing unit (not shown) suitable to process the electrical signal in output from the comparator circuit.

For example, such processing unit is a conventional processing unit of the DSP (Digital Signal Processor) type suitable to perform a peak detection of the electrical signal, an operation of comparison with a predetermined threshold for determining the presence or absence of the modulation frequency and thus, of the service information by the optical amplification unit 30 and the processing of the electrical signal, according to system requirements.

In the presence of service informations by the optical amplification unit 30, the processing unit can send such informations to the second control unit 20 according to known methods—for example, using an external Digital Communication Network.

In the embodiment in which the service informations generated by the optical amplification unit 30, on account of the service informations received from the first control unit 10, are superimposed on the backward WDM optical signal through the magneto-optical attenuator 35, the processing unit of the control device 12 uses such informations for generating further service informations to be sent, through the magneto-optical attenuator 11, to the optical amplification unit 30.

When the length of the link requires it, the optical communication lines 1 of FIGS. 1 and 2 comprise a plurality of optical amplification units 30 (not shown) totally similar to those described with reference to FIGS. 5 and respectively, 6.

Even though in the described embodiment of the optical communication line 1 the modulation frequency used for transmitting the service informations from the control units 10, 20 is different from the modulation frequency used for transmitting the service informations from the optical amplification unit(s) 30, in the optical communication line 1 of the invention the above modulation frequencies can also be equal (for example, 100 KHz).

In this case, the service informations transmitted by the control units 10, 20 will be differentiated by that transmitted by the optical amplification units) 30 through conventional identification codes. Moreover, the processing units of the control devices 12, 22 and 32 will be provided with suitable conventional electronic circuitry suitable to decode such codes.

Moreover, in a preferred embodiment, the optical communication line 1 also comprises an optical pre-amplifier (not shown) along the optical fibre 40, at the input of the second unit 20, and, in the case of the bidirectional optical communication line 1 of FIG. 2, also along the optical fibre 40′, at the input of the first unit 10.

Such optical pre-amplifier is of the conventional type, for example, of the erbium-doped active optical fibre type.

According to an aspect of the invention, the optical communication line of FIG. 1 or 2 is totally similar to that described above except in that the optical amplification unit(s) 30 is/are of the conventional type and is/are suitable to transmit/receive service informations according to a conventional method.

According to a further aspect of the invention, the optical communication line of FIG. 1 or 2 is totally similar to that described above except in that the control units 10 and 20 are suitable to transmit/receive service informations to/from the optical amplification unit 30 according to a conventional method.

FIG. 8 shows an optical communication system according to an aspect of the invention, comprising the optical communication line of FIG. 1 and a first and a second terminal station 50, 60.

As regards the features of the optical communication line 1, reference shall be made to what described above.

According to a first embodiment, the first terminal station 50 comprises a plurality of laser sources suitable to provide a plurality of optical signals at different wavelengths from each other, a corresponding plurality of optical modulators, at least one wavelength division multiplexing device and an optical power amplifier (not shown). Moreover, it can comprise a pre-compensation chromatic dispersion section.

For example, the first terminal station comprises 40, 64 or 100 laser sources.

The laser sources are suitable to emit continuous optical signals at the typical wavelengths of optical fibre telecommunications such as, for example, in the interval of about 1300-1700 nm and, typically, in the third transmission window of the optical fibres around 1500-1600 nm.

The optical modulators are conventional amplitude modulators, for example of the Mach Zehnder interferometric type. They are piloted by respective electrical signals carrying the main informations to be transmitted along the optical communication line 1 so as to modulate the intensity of the continuous optical signals in output from the laser sources and provide a plurality of optical signals at a predetermined bit rate. For example, said bit rate is of 2.4 Gbit/s, of 10 Gbit/s or of 40 Gbit/s.

Such signals can, for example, be coded through error correction codes of the FEC (Forward Error Correction) type.

The optical signals thus modulated are then wavelength multiplexed by one or more multiplexing devices arranged in one or more multiplexing sub-bands.

Such devices consist, for example, of a conventional fused fibre or planar optics coupler, a Mach-Zehnder device, an AWG (Arrayed Waveguide Grating), an interferential filter, a micro-optics filter and the like.

The WDM optical signal in output from the multiplexing device is then amplified by the optical power amplifier and sent to the first control unit 10 of the optical communication line 1 where it is processed as described above.

The optical power amplifier is, for example, a conventional erbium-doped active optical fibre optical amplifier.

According to an alternative embodiment, the terminal station 50 also comprises a plurality of wavelength converter devices.

In this case, the laser sources emit continuous optical signals at any wavelength, equal or different from one another, and the wavelength converter devices convert such wavelengths into a corresponding plurality of wavelengths that are different from each another and suitable for transmission along the optical communication line 1.

Such wavelength converter devices are suitable to receive a signal at a generic wavelength and convert it into a signal at a predetermined wavelength according to what described, for example, in patent U.S. Pat. No. 5,267,073 by in the name of the same Applicant.

Each wavelength converter device preferably comprises a photodiode for converting the optical signal into an electrical one, a laser source and an electro-optical modulator, for example of the Mach-Zehnder type for modulating the optical signal generated by the laser source at the predetermined wavelength, with the electrical signal converted by the photodiode.

Alternatively, such converter device can comprise a photodiode and a laser diode directly modulated by the electrical signal of the photodiode so as to convert the optical signal at the predetermined wavelength.

The second terminal station 60 comprises at least one demultiplexing device and a plurality of photodetectors (not shown).

The demultiplexing device comprises one or more conventional devices arranged in one or more demultiplexing sub-bands, suitable to demultiplex the WDM optical signal into a plurality of optical signals at different wavelengths from each other.

Such devices, for example, consist of a conventional fused fibre or planar optics coupler, a Mach-Zehnder device, an AWG (Arrayed Waveguide Grating), an interferential filter, a micro-optics filter and the like.

The plurality of optical signals in output from the multiplexing device is then converted into corresponding electrical signals by the corresponding plurality of photodetectors.

The latter are, for example, conventional photodiodes.

The electrical signals in output from the photodetectors are then processed according to the applications.

For example, in the presence of FEC error correction codes, they are decoded and, if the optical communication line 1 is submarine, they are optically retransmitted on a land communication line.

FIG. 9 shows a bidirectional optical communication system according to an aspect of the invention, comprising the bidirectional optical communication line of FIG. 2 and a first and a second terminal station 50, 60.

As regards the features of the optical communication line 1 of FIG. 2, reference shall be made to what already disclosed above.

On the other hand, as regards the terminal stations 50 and 60, they are totally similar to those described with reference to FIG. 8 except in that the second terminal station 60 is also suitable to transmit a backward WDM optical signal along the second optical fibre 40′ and the first terminal station 50 is also suitable to receive said backward WDM optical signal.

More in particular, the second terminal station 60 also comprises a plurality of laser sources suitable to provide a plurality of optical signals, a corresponding plurality of optical modulators, a wavelength division multiplexing device for providing the backward WDM optical signal, an optical power amplifier and optionally, a plurality of wavelength converter devices (not shown).

As regards the features of the plurality of laser sources, of the plurality of optical modulators, of the wavelength division multiplexing device, of the optical power amplifier and of the plurality of wavelength converter devices, reference shall be made to what described above with reference to the first terminal station 50.

Moreover, the first terminal station 50 also comprises a demultiplexing device for demultiplexing the backward WDM optical signal into a plurality of optical signals at different wavelengths and a plurality of photodetectors for converting said optical signals into corresponding electrical signals.

As regards the features of the demultiplexing device and of the plurality of photodetectors, reference shall be made to what described above with reference to the second terminal station 60.

1. An optical communication line (1) comprising
a first control unit (10);
an optical transmission fibre (40) for transmitting an optical signal, connected to the first control unit (10); and
an optical amplification unit (30) inserted along said optical transmission fibre (40) for amplifying the optical signal, said optical amplification unit (30) comprising, in turn,
an optical amplifier (34) for amplifying the optical signal,
a magneto-optical attenuator (31) connected to said optical amplifier (34), and
a control device (32) for regulating the light transmissivity of the magneto-optical attenuator (31),
characterised in that
the first control unit (10) comprises a magneto-optical attenuator (11) and a control device (12) for regulating the light transmissivity of the magneto-optical attenuator (11) so as to superimpose service informations on the optical signal; and in that
in the optical amplification unit (30), the control device (32) is suitable to regulate the light transmissivity of the magneto-optical attenuator (31) so as to superimpose service informations on the optical signal.

2. An optical communication line (1) according to claim 1, wherein in the optical amplification unit (30) the control device (32) is suitable to modulate the light transmissivity of the magneto-optical attenuator (31) around a predetermined operating point so as to modulate the amplitude of the optical signal in function of the predetermined service informations to be transmitted.

3. An optical communication line (1) according to claim 1 or 2, wherein in the first control unit (10) the control device (12) is suitable to modulate the light transmissivity of the magneto-optical attenuator (11) around a predetermined operating point so as to modulate the amplitude of the optical signal in function of the service informations to be transmitted.

4. An optical communication line (1) according to any one of claims from 1 to 3, wherein the service informations have a transmission band comprised between 10 and 300 KHz.

5. An optical communication line (1) according to claim 4, wherein the service informations have a transmission band comprised between 20 and 200 KHz.

6. An optical communication line (1) according to any one of claims from 1 to 5, also comprising a second control unit (20).

7. An optical communication line (1) according to claim 6, wherein the optical transmission fibre (40) is inserted between the first control unit (10) and the second control unit (20) for transmitting the optical signal from the first control unit (10) to the second control unit (20).

8. An optical communication line (1) according to claim 6 or 7, wherein the second control unit (20) comprises a control device (22) suitable to extract service informations from the optical signal.

9. An optical communication line (1) according to any one of claims from 1 to 8, also comprising a second optical transmission fibre (40′) for transmitting a backward optical signal.

10. An optical communication line (1) according to claim 9, wherein the optical amplification unit (30) also comprises a backward optical amplifier (37) for amplifying the backward optical signal.

11. An optical communication line (1) according to claim 9 or 10, wherein the optical amplification unit (30) also comprises a backward magneto-optical attenuator (35).

12. An optical communication line (1) according to claim 11, wherein the control device (32) of the optical amplification unit (30) is also suitable to modulate the light transmissivity of the backward magneto-optical attenuator (35) so as to superimpose service informations on the backward optical signal.

13. An optical communication line (1) according to any one of claims from 6 to 8 and according to any one of claims from 9 to 12, wherein the second control unit (20) comprises a backward magneto-optical attenuator (21) connected to the second optical transmission fibre (40′).

14. An optical communication line (1) according to claim 13, when depending on claim 8, wherein the control device (22) of the second control unit (20) is also suitable to modulate the light transmissivity of the magneto-optical backward attenuator (21) so as to superimpose service informations on the backward optical signal.

15. An optical communication line (1) according to any one of claims from 9 to 14, wherein the control device (12) of the first control unit (10) is also suitable to extract the service informations from the backward optical signal.

16. An optical amplification unit (30) comprising
an optical amplifier (34) for amplifying an optical signal,
a magneto-optical attenuator (31) connected to said optical amplifier (34), and
a control device (32) for regulating the light transmissivity of the magneto-optical attenuator (31),
characterised in that the control device (32) is suitable to regulate the light transmissivity of the magneto-optical attenuator (31) so as to superimpose service informations on the optical signal.

17. An optical communication line (1) comprising
an optical transmission fibre (40) for transmitting an optical signal;
a first control unit (10) for sending service informations along the optical transmission fibre (40); and
an optical amplification unit (30) inserted along said optical transmission fibre (40) for amplifying the optical signal, said optical amplification unit (30) comprising, in turn,
an optical amplifier (34) for amplifying the optical signal,
a magneto-optical attenuator (31) connected to said optical amplifier (34),
a control device (32) for regulating the light transmissivity of the magneto-optical attenuator (31),
characterised in that in the optical amplification unit (30), the control device (32) is suitable to regulate the light transmissivity of the magneto-optical attenuator (31) so as to superimpose service informations on the optical signal.

18. An optical communication line (1) comprising
an optical transmission fibre (40) for transmitting an optical signal;
a first control unit (10) for sending service informations along the optical transmission fibre (40), and
an optical amplification unit (30) inserted along said optical transmission fibre (40) for amplifying the optical signal,
characterised in that the first control unit (10) comprises a magneto-optical attenuator (11) and a control device (12) for regulating the light transmissivity of the magneto-optical attenuator (11) so as to superimpose the service informations on the optical signal.

19. A control unit (10; 20) comprising
a magneto-optical attenuator (11; 21), and
a control device (12; 22) for regulating the light transmissivity of the magneto-optical attenuator (11; 21),
characterised in that the control device (12; 22) is suitable to regulate the light transmissivity of the magneto-optical attenuator (11; 21) so as to superimpose service informations on an optical signal.

20. An optical communication system comprising
a first terminal station (50) for providing an optical signal;
a first control unit (10) for transmitting service informations, connected to said first terminal station (50);
a second terminal station (60) for receiving said optical signal;
a second control unit (20) for receiving service informations, connected to said second terminal station (60);
an optical transmission fibre (40) for transmitting the optical signal from the first control unit (10) to the second control unit (20); and
an optical amplification unit (30) inserted along said optical transmission fibre (40) for amplifying the optical signal,
characterised in that the first control unit (10) comprises a magneto-optical attenuator (11) and a control device (12) for regulating the light transmissivity of the magneto-optical attenuator (11) so as to superimpose service informations on the optical signal provided by the first terminal station (50).

21. An optical communication system comprising
a first terminal station (50) for providing an optical signal;
a first control unit (10) for transmitting service informations, connected to said first terminal station (50);
a second terminal station (60) for receiving said optical signal;
a second control unit (20) for receiving service informations, connected to said second terminal station (60);
an optical transmission fibre (40) for transmitting the optical signal from the first control unit (10) to the second control unit (20) and
an optical amplification unit (30) inserted along said optical transmission fibre (40) for amplifying the optical signal, said optical amplification unit (30) comprising, in turn,
an optical amplifier (34) for amplifying the optical signal,
a magneto-optical attenuator (31) connected to said optical amplifier (34),
a control device (32) for regulating the light transmissivity of the magneto-optical attenuator (31),
characterised in that in the optical amplification unit (30) the control device (32) is suitable to regulate the light transmissivity of the magneto-optical attenuator (31) so as to superimpose service informations on the optical signal.
